(19) United States
(12) Patent Application Publication
(10) Pub. No.: US 2023/0283759 A1
(43) Pub. Date: Sep. 7, 2023

(54) SYSTEM AND METHOD FOR PRESENTING THREE-DIMENSIONAL CONTENT

(71) Applicant: Looking Glass Factory, Inc., Brooklyn, NY (US)

(72) Inventors: Shawn Michael Frayne, Brooklyn, NY (US); Caleb Johnston, Brooklyn, NY (US); Alexander Duncan, Brooklyn, NY (US); Robert Kodadek, Brooklyn, NY (US); Michelle Senteio, Brooklyn, NY (US); Bryan Christopher Brown, Brooklyn, NY (US); Albert Hwang, Brooklyn, NY (US); Casey Pugh, Brooklyn, NY (US)

(21) Appl. No.: 18/117,834

(22) Filed: Mar. 6, 2023

Related U.S. Application Data
(60) Provisional application No. 63/316,786, filed on Mar. 4, 2022.
(60) Provisional application No. 63/347,731, filed on Jun. 1, 2022.

(51) Int. Cl. H04N 13/261; H04N 13/243; H04N 19/597

(52) U.S. Cl. CPC H04N 13/261; H04N 13/243; H04N 19/597; G06T 2207/20081

(57) ABSTRACT

A system and method for presenting three-dimensional content that can present the three-dimensional content with a fidelity that can be matched to a fidelity or perceivable depth achievable by the display. The system or method can include receiving content, converting the content to a shared representation that can be used for any display, displaying the content on the display via the shared representation.

### CROSS-REFERENCE TO RELATED APPLICATIONS

This application claims the benefit of U.S. Provisional Application No. 63/316,786 filed 4 Mar. 2022 and U.S. Provisional Application No. 63/347,731 filed 1 Jun. 2022, each of which is incorporated in its entirety by this reference.

### TECHNICAL FIELD

This invention relates generally to the three-dimensional imagery field, and more specifically to a new and useful system and method in the three-dimensional imagery field.

### BRIEF DESCRIPTION OF THE FIGURES

FIG. 1 is a schematic representation of the apparatus.

FIG. 2 is a schematic representation of the method.

FIG. 3 is a schematic representation of an example of two-dimensional and three-dimensional content shared in a browser.

FIG. 4 is a schematic representation of an example of three-dimensional content in a browser being displayed on a multiviewer display.

FIG. 5 is a schematic representation of an example of three-dimensional content in a browser being displayed on a head mounted display.

FIG. 6 is a schematic representation of an example of three-dimensional content in a browser being displayed by a change in a displayed image (e.g., as viewer moves the display, changing in time such as a wiggle gif, etc.).

FIG. 7 is a schematic representation of examples of content, a shared rendering format, and displays.

FIG. 8 is a schematic representation of an example of a quilt image (particularly but not exclusively for a quilt image accounting for 1D parallax such as vertical or horizontal parallax only).

FIG. 9 is a schematic representation of an example of a quilt image (particularly but not exclusively for a quilt image that includes 2D parallax, such as images in an image column including different vertical perspective and image in an image row having different horizontal perspective).

FIG. 10 is a schematic representation of a group of quilt images. Each quilt image can individually account for 1D parallax (e.g., as in FIG. 8), and when used in combination can account for 2D parallax. For example, Quilt [1→N] could show horizontal parallax while views 1→1′″ could show vertical parallax.

FIG. 11 is a schematic representation of an example of viewing three-dimensional content (e.g., a lightfield image) responsive to changes in a viewing angle (e.g., detected using a gyroscope of, connected to, etc. the display)

FIG. 12 is an exemplary pictographic representation of exemplary content viewed and/or shown from different perspectives.

FIG. 13 is a schematic representation of an example of using artificial intelligence to generate three-dimensional content from one or more images.

FIGS. 14A and 14B are schematic representations of examples of encoding methods for a quilt video.

FIGS. 15A and 15B are schematic representations of examples of double lenticularized quilt images.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

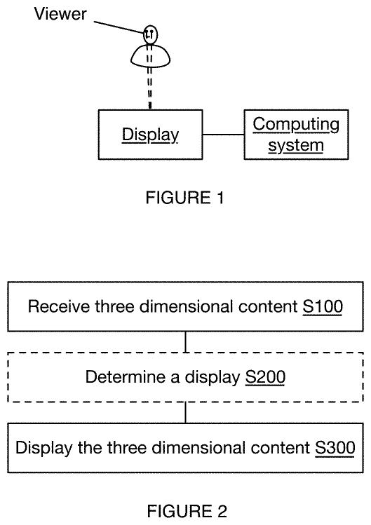

As shown in FIG. 1, the system can include a computing system and a display. The computing system preferably operates a browser, where a viewer can interact with (e.g., select) three-dimensional content (e.g., to be perceived, viewed, transmitted to a display, etc.). However, the computing system can additionally or alternatively operate a unique application and/or any suitable executable(s).

As shown in FIG. 2, the method can include receiving content; optionally, determining a display; displaying the three-dimensional content; and/or any suitable steps.

The system and/or method preferably function to enable three-dimensional content to be shared (e.g., distributed, viewed, observed, etc.) between a content creator and a plurality of viewers. The shared content is preferably viewable by any viewer (e.g., with access to a link or share to the shared content). However, the shared content can be behind a paywall, application, user group, specific display type and/or shared content format, and/or can otherwise be viewable by any suitable viewer(s). A quality (e.g., immersiveness, depth, perception of 3Dness, etc.) of the shared content can depend, for example, on a viewer display. However, the system and/or method can otherwise function.

### 2. Benefits

Variations of the technology can confer several benefits and/or advantages.

First, the inventors have discovered that using a common formatting structure, three-dimensional content can be disseminated and perceived (e.g., perceived as three-dimensional) using a wide variety of displays (e.g., from the same embedding). In an illustrative example (as shown for instance in FIG. 7), images, videos, models, 3D scenes, and/or other content (e.g., 2D content, 3D content, etc.) can be rendered in an image-based representation (e.g., a quilt image, an RGBD image, a depth image, a representation as disclosed in U.S. patent application Ser. No. 17/862,846 titled ‘SYSTEM AND METHOD FOR GENERATING LIGHT FIELD IMAGES’ filed 12 Jul. 2022 which is incorporated in its entirety by this reference, etc.). In this illustrative example, the rendered image can then be displayed on any suitable display (e.g., a multi-viewer lightfield display, a single viewer lightfield display, a holographic display, a virtual reality headset, an augmented reality headset, a mobile device, a laptop, a tablet, a computer monitor, an autostereoscopic display, a superstereoscopic display, etc.) and perceived as three-dimensional. Variations of these examples can enable the content to be perceived with the depth richness or immersiveness of a display used to present the content. For instance, a wiggle-gif or input-responsive (e.g., gyro, cursor scroll, etc.) image can be used on a two-dimensional display (e.g., a computer screen, smart phone display, etc.), a plurality of views can be simultaneously presented on a parallax-based display (e.g., on an autostereoscopic display, superstereoscopic display, 3D glasses-based display, etc.), and a full parallax image can be presented on other displays (e.g., VR or AR headsets, tracked displays, etc.), where each of the images can be encoded in a common format that is locally or remotely formatted for display on the device.

Second, variants of the technology can enable three-dimensional content to be rendered (e.g., rendered only once) or streamed and be displayed on a wide variety of displays (e.g., contemporaneously, simultaneously, concurrently, nonconcurrently, etc.). In a specific example, a single content format (e.g., a quilt image, RGBD data and/or depth image, a depth quilt, neural radiance fields, etc.) can be used by any device to display 3D content (e.g., rather than requiring a unique or proprietary format for a device). This format can, for instance, enable (e.g., allow, facilitate, etc.) a user to send a URL to refer to a 3D scene that is responsive towards and compatible with many viewing modalities (e.g., natively 3D ones like XR HMD, wiggle gifs, gyro-responsive light fields, etc.).

Third, variants of the technology can enable display of holographic content within a browser (e.g., using browser technologies such as HTML, CSS, JavaScript, etc.). In an illustrative example, a specific view within a quilt image can be selectively presented with HTML and/or CSS, and JavaScript can be used to control the HTML and/or CSS based on a viewer input (e.g., from a touch screen, mouse, gyroscope on the device, etc.).

However, variants of the technology can confer any other suitable benefits and/or advantages.

### 3. System

As shown in FIG. 1, the system can include a computing system and a display. The system preferably functions to display 3D content (e.g., 3D images, 3D video, etc.) to viewer(s). The system can additionally or alternatively function to generate 3D content (e.g., convert a format of 3D content to a universal 3D content format) and/or can otherwise function.

The display preferably functions to display the content as a three-dimensional image. The display can additionally or alternatively display two-dimensional content (e.g., concurrently with displaying 3D content), display the three-dimensional content in 2D, and/or can otherwise function. The display is preferably connected to (e.g., tethered display) and/or integrated with (e.g., standalone display) the computing system (e.g., wired connection, wireless connection, etc.), but can additionally or alternatively interface with a computing system or other component(s) in any manner (e.g., mobile headsets, hybrid solutions, etc.).

The display can be a multi-viewer display (e.g., a display that enables two or more viewers to perceive content as three dimensional at the same time), a single-viewer display (e.g., a display that enables a single viewer to perceive content as three-dimensional at a time), and/or can be any suitable display.

Exemplary displays include: computer monitors, tablets, laptops, smart phones, extended reality (XR) devices (e.g., augmented reality (AR) devices, mixed reality (MR) devices, virtual reality (VR) devices, etc.), virtual reality headsets (e.g., Oculus, HTC Vive, Valve, Sony PlayStation VR, etc.), augmented reality headsets (e.g., smart glasses, Microsoft HoloLens, Heads Up Displays, handheld AR, holographic display, etc.), superstereoscopic display (e.g., a display as disclosed in U.S. patent application Ser. No. 17/328,076 filed 24 May 2021 titled ‘SUPERSTEREOSCOPIC DISPLAY WITH ENHANCED OFF-ANGLE SEPARATION’, U.S. patent application Ser. No. 17/332,479 filed 27 May 2021 titled ‘SYSTEM AND METHOD FOR HOLOGRAPHIC DISPLAYS’, and/or U.S. patent application Ser. No. 17/326,857 filed 21 May 2021 titled ‘SYSTEM AND METHOD FOR HOLOGRAPHIC IMAGE DISPLAY’, each of which is incorporated in its entirety by this reference; etc.), autostereoscopic displays, multi-view display, 2D-plus-depth display, tracked displays (e.g., as disclosed for example in U.S. patent application Ser. No. 17/877,757 titled ‘SYSTEM AND METHOD FOR HOLOGRAPHIC DISPLAYS’ filed 29 Jul. 2022, which is incorporated in its entirety by this reference), multi-viewer displays (e.g., 3D displays where images can be perceived as 3D by more than one viewer simultaneously), single-viewer displays (e.g., 3D displays where only a single viewer can perceive an image or subject thereof as 3D but where potentially other viewers can perceive a 2D image), 3D television (e.g., active shutter system, polarized 3D system, holographic displays (e.g., Sony Spatial Reality Display, Lume Pad, etc.), and/or any suitable display(s) can be used.

In variants, the display can enable display content with low, medium, and/or high richness of content (e.g., a perception of content as three-dimensional, resolution, depth resolution, color richness, immersive content, etc.). For example, a computer monitor, smartphone display, and/or other displays can have a low richness of content; a superstereoscopic display, holographic display, and/or other display can have a medium and/or high richness of content; and a headset (e.g., XR, MR, VR, AR, etc. headset) can have a high richness of content. The same content can be provided (e.g., viewed on) each and/or any of these displays (e.g., simultaneously, sequentially, contemporaneously, concurrently, etc. by one or more viewers), where a richness of the perception of the content can depend on the display used.

In some variants of the system, more than one display can receive (and present) the content contemporaneously. Each display is preferably connected to the same computing system (e.g., receive content from a shared database, website, embedded link, etc.). However, the different displays can be connected to different computing systems (e.g., each display can include a separate integrated computing system which can format the shared representation into a display specific format for displaying) and/or have any suitable distributed computing structure. However, more than one display can display the content at any suitable time.

The computing system can function to render the content (e.g., converting the content to a shared format that can be used across platforms), generate 2D and/or 3D content, share content, and/or can otherwise function. The computing system preferably runs a browser (e.g., web browser, Internet browser, etc.) where the content is shared through the browser. Any browser (e.g., Google Chrome, Safari, Microsoft Edge, Internet Explorer, Firefox, Opera, BlackBerry, Android Browser, Maemo, MeeGo, Sailfish, Tizen, iOS, etc.) can be used. However, the computing system can additionally or alternatively run a separate application (e.g., a custom application), and/or any suitable executable programs for sharing the content. The computing system can be local (e.g., integrated into the display, connected to the display, etc.), be remote (e.g., server, cloud computing, database, etc.), and/or can otherwise be distributed.

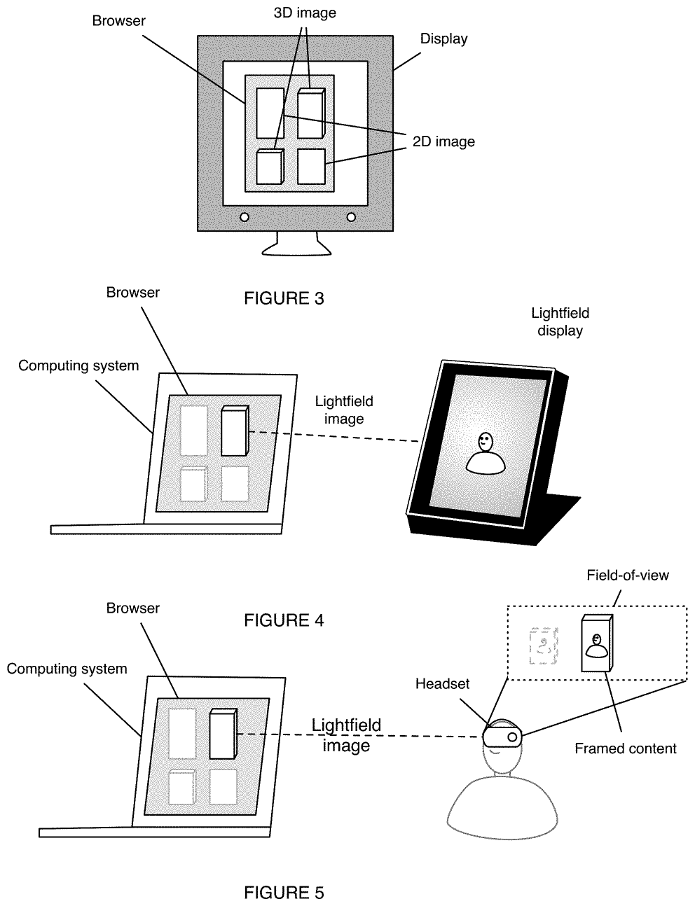

In an illustrative example (as shown for instance in FIG. 3), the browser can present (e.g., through the display) 2D and 3D content (e.g., 2D images and 3D images of the same and/or different scenes) contemporaneously. In variations of this illustrative example, a viewer can interact with (e.g., select) the 3D content to be shared in a separate display, to enable a motion of the content (e.g., to enable perception of the content as three-dimensional such as via cursor-controlled view selection), and/or the content can otherwise be interacted with. However, the browser can exclusively share 2D content or 3D content, and/or can otherwise be configured to present the content.

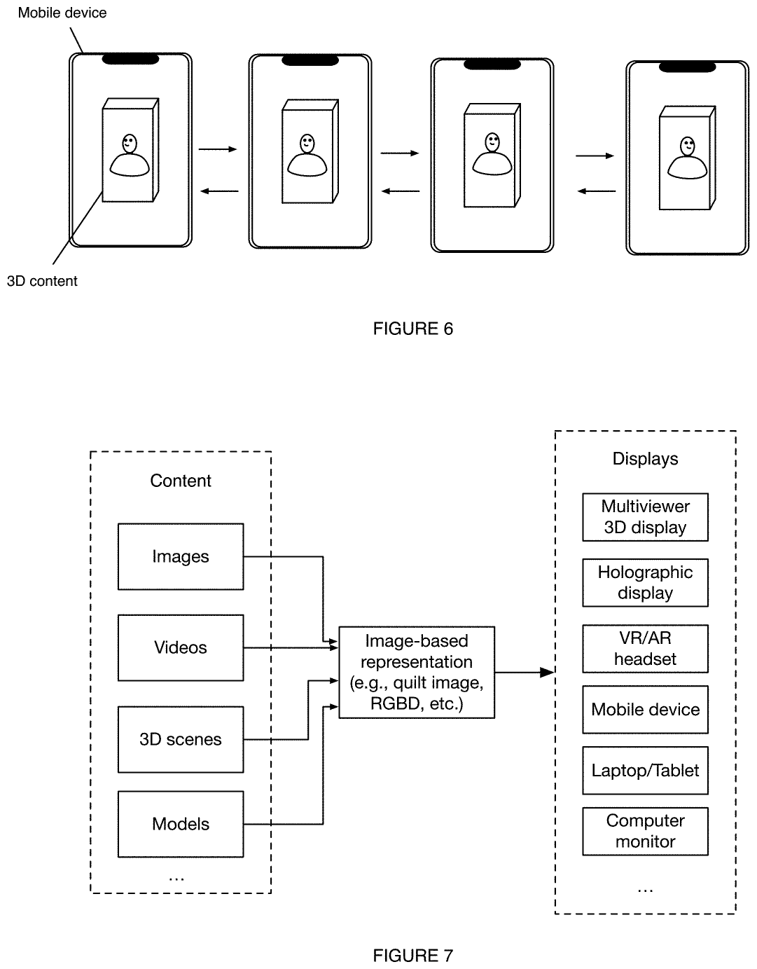

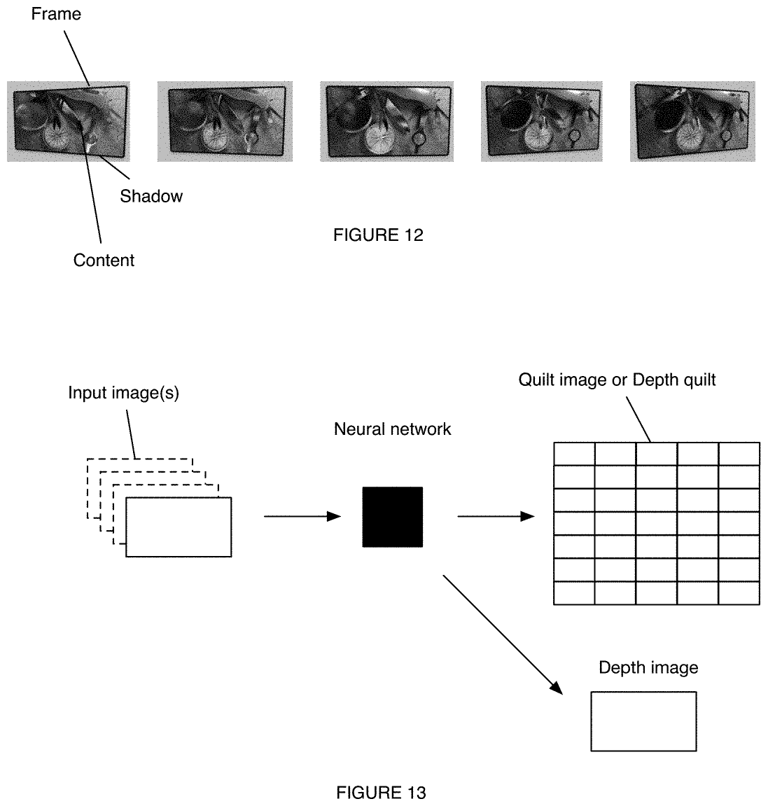

Content that is 3D can, for instance, be bounded by bounding box (e.g., a frame, box, etc. such as with an arbitrary shape, with arbitrary size, as shown for example in FIG. 12, etc.), which can facilitate a perception of portions of the content as three dimensional. For example, 3D content can be presented within a frame of a field-of-view (as shown for instance in FIG. 5), presented within a bounding box (as shown for instance in FIG. 6), presented within an optical volume defined by a display (as shown for instance in FIG. 4), and/or can otherwise be presented within a bounding box. In some variants, an aspect (e.g., aspect ratio, shading, shape, orientation, lighting, color, background color, etc.) of the bounding box can change which can function enhance a perception (e.g., a ‘pop out’ effect) of the content as three dimensional (e.g., by providing context cues for the perception of the content as three dimensional). In other variants (which can be combined with or separate from the preceding variant), a shadow of the bounding box can change with different views (e.g., based on a line of sight for the bounding box relative to the view such as assuming a light source proximal a viewer, to produce apparent dimming of a view as a bounding box changes, etc.). However, the content can be unbounded (e.g., can fill a field-of-view, can fill a display screen, etc.), and/or can be bounded in any manner.

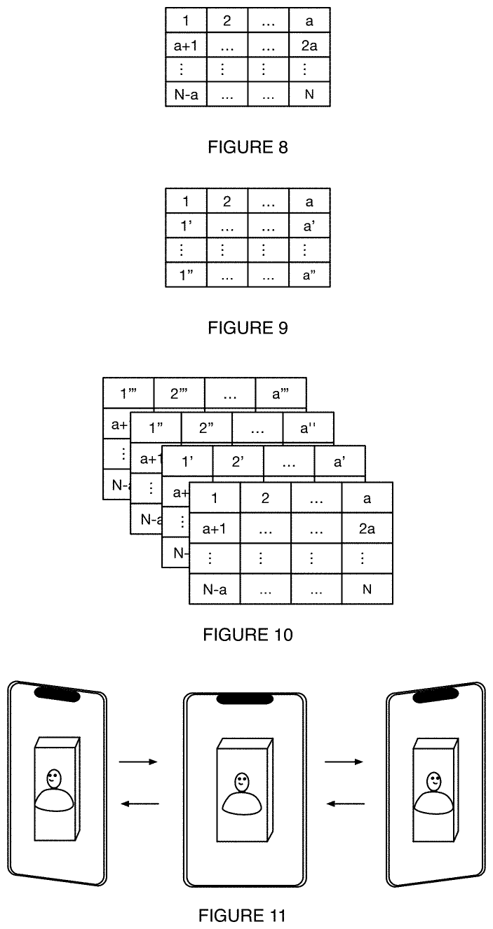

The shared content representation (e.g., rendered 3D content) can be rendered as a quilt image (e.g., a plurality of images stored in a common container in a specified order, as shown for example in FIG. 8 and/or FIG. 9, etc.), as a depth image (e.g., RGBD image), as a depth quilt (e.g., a quilt image made up of a plurality of RGBD images), a plurality of quilt images (e.g., as shown for instance in FIG. 10), can have a format as disclosed in U.S. patent application Ser. No. 17/226,404 titled ‘SYSTEM AND METHOD FOR GENERATING LIGHT FIELD IMAGES’ filed 9 Apr. 2021 incorporated in its entirety by this reference, and/or can have any suitable format. In a first variation, as shown for instance in FIG. 8, 3D content can include information for parallax (e.g., 3D perception) in a single axis (e.g., a horizontal viewing axis, vertical viewing axis, diagonal viewing axis, etc.). In a second variation, as shown for instance in FIG. 9, 3D content can include information for parallax in two axes (e.g., effectively mimicking full parallax information). However, the 3D content can include any suitable information.

The computing system can include one or more: graphic processing units (GPUs), central processing units (CPUs), tensor processing units (TPUs), microprocessors, and/or any other suitable processor(s). In some variants, the computing system can prepare and/or present the content (e.g., 2D content, 3D content, etc.) without using a GPU (e.g., because an image-based format is included).

In some variants, the computing system can include (e.g., be connected to, receive data from, be collocated with, etc.) one or more sensors, which can function to detect one or more viewer property. Examples of sensors can include image sensors (e.g., camera(s), depth camera(s), etc.), tracking sensors (face tracking, eye tracking, gaze tracking, etc.), inertial measurement units (e.g., accelerometer, gyroscope, magnetometer, etc.), light sensor, microphone, and/or any suitable sensor(s).

In some variants, the system can include an image acquisition system (e.g., a camera array, a plurality of cameras, a depth camera, etc.) which can function to acquire one or more images (e.g., a plurality of images with different perspectives, depth image(s), etc.) of a subject and/or scene. The image acquisition system can be used, for instance, to enable real or near-real time three-dimensional communication between users (e.g., between a first user operating a first system and a second user operating a second system), where the image acquisition system can acquire image(s) of a first user and transmit the image(s) of the first user to the second user (e.g., to be displayed to the second user).

### 4. Method

As shown in FIG. 2, the method can include receiving content S100; optionally, determining a display S200; displaying the three-dimensional content S300; and/or any suitable steps. The method preferably functions to share (e.g., between viewer(s), between content creator(s) and viewer(s), etc.) content (particularly but not exclusively 3D content). As shown for example in FIG. 7, content (e.g., input content) can include still images (e.g., 2D images, RGB images, depth images, RGBD images, etc.), videos (e.g., 2D videos, 3D videos, RGBD videos, etc.; videos where frames of the video include still images; etc.), 3D scenes (e.g., 3D models, 3D renderings, CAD, molecular structures, architecture drawings, etc.), neural radiance field (NeRF) representations (e.g., nerfies such as 3D self-portrait, 3D reconstructed selfie, etc.), models (e.g., mesh based models, polygon models, etc.), and/or any suitable content can be used. The content can optionally include extrasensory content (e.g., audio, scent, etc.) that can be presented contemporaneously, concurrently, simultaneously, with a delay, and/or can otherwise be presented to the viewer(s). However, the method can additionally or alternatively function to convert content to a format (e.g., a format that is display agnostic), and/or can otherwise function.

The method is preferably performable in real or near-real time (e.g., on demand when a viewer wishes to interact with content, with content upload such as within less than about 10 seconds, 20 seconds, 60 seconds, 120 seconds, etc. per frame or image converting content into a standardized format and/or into a displayable format). However, the method (or steps thereof) can be performed delayed (e.g., delayed relative to content upload, delayed relative to viewer interaction, delayed relative to rendering, etc.), and/or with any suitable timing.

The method is preferably agnostic to input content and/or output display. For example, any type of 2D or 3D content can be processed by the method to a shared format and/or representation where the shared format and/or representation can then be used by any type of display (e.g., potentially with a display specific rendering step such as facilitated by an API, for instance webXR, webVR, webGL, etc.; by a native application such as Unity, Blender, etc.; etc.). However, the method can depend on the content format (e.g., file type, container, etc.), and/or can otherwise depend on or be independent of the input content and/or output display.

Receiving the content S100 preferably functions to access content at a computing system and/or send the content to a display (e.g., local computing system of the display. The content is preferably accessed through the internet but can additionally or alternatively be accessed from a local file, through a local access network, a personal area network, a campus area network, a metropolitan area network, a radio access network, a wide area network, and/or through any suitable network.

Receiving the content can include formatting the content (e.g., rendering the content such that a display can display the content as 3D; transcoding the content from a proprietary, device-specific, storage-specific, etc. format to a universal format or representation; etc.). For instance, content can be transcoded to a quilt image, an RGBD image (e.g., depth image), a depth quilt, a light field (e.g., describing the amount of light flowing in different directions of the scene; also referred to as a “radiance field”, “plenoptic function”, etc.), a video (e.g., where each frame of the video is one of the preceding such as a quilt image, depth quilt, light field, depth image, etc.), a compressed quilt image or quilt video (e.g., in a format as disclosed in U.S. patent application Ser. No. 17/226,404 titled ‘SYSTEM AND METHOD FOR GENERATING LIGHT FIELD IMAGES’ filed 9 Apr. 2021 incorporated in its entirety by this reference; which can be particularly beneficial for reducing a quilt image size facilitating transmission and sharing of the content), and/or in any suitable format.

A quilt image, as shown for example in FIG. 8, is preferably an a×b array of views, where a and b can be any number between 1 and N (e.g., the total number of views). The product of a and b is preferably N, but can be greater than or less than N (e.g., when one or more views is discarded). Within the quilt image, the set of views can be arranged (or indexed) in a raster (e.g., starting at the top left and rastering horizontally through views to the bottom right, starting at the top left and rastering vertically through views to the bottom right, starting at the bottom left of the quilt image and rastering horizontally through views to the top right, starting at the bottom left of the quilt image and rastering vertically through views to the top right, etc.), in a boustrophedon, randomly, and/or in any suitable order. The view arrangement within the quilt image preferably mirrors the arrangement (e.g., position) of the source camera within the camera array that sampled the respective views, but can be otherwise determined. The starting view can be associated with the first camera (e.g., wherein each camera is assigned a camera number), the left most camera of the camera array, the right most camera of the camera array, the center camera of the camera array, the top most camera of the camera array, the bottom most camera of the camera array, a random camera, and/or any suitable camera of the camera array. However, the quilt image can be arranged in any suitable manner. For example, each view can be a separate images (e.g., with different containers), where the images are reformatted to be combined into a single image file (e.g., a single container, such as the quilt image in this example). A depth quilt is preferably analogous to a quilt image where each view has depth information associated therewith. However, a subset of views in a depth quilt can include depth information (e.g., 1 view per view column of the depth quilt, 1 view per view column of the depth quilt, 1 view per m views of the depth quilt, key views of the depth quilt, etc.) and/or any suitable views of the depth quilt can have associated depth information.

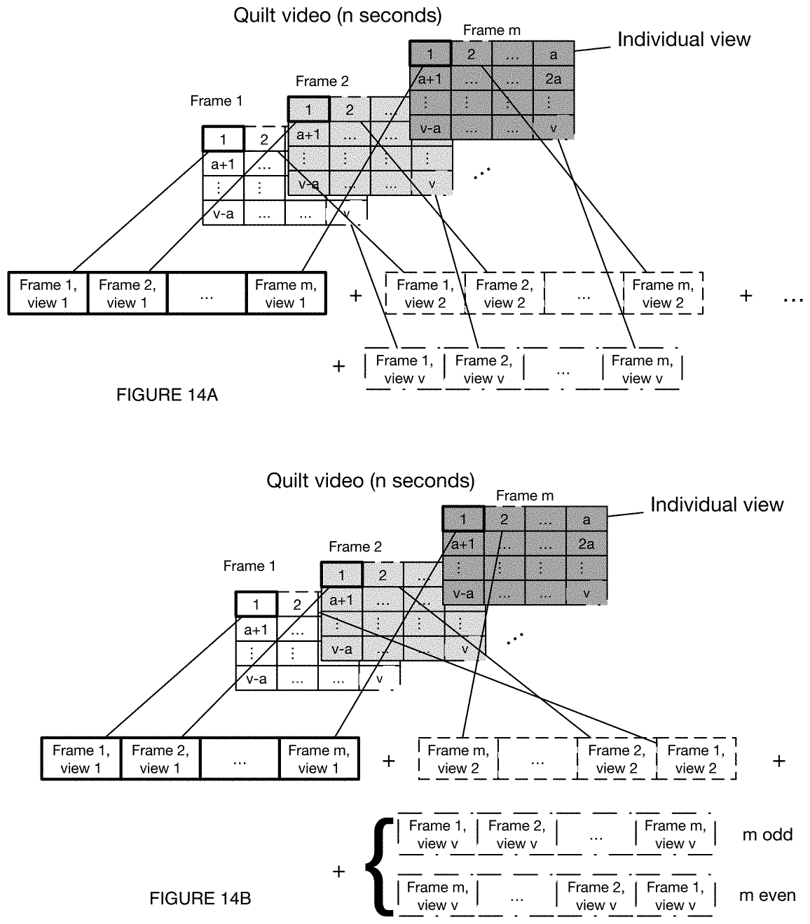

Examples of compressed quilt image formats include video compression (e.g., where each view of the quilt is a frame of the video, where a subset of the video frames can be key frames and the remaining frames can difference frames relative to the key frames), a depth quilt, a depth image, a 3D representation (e.g., voxels, rays, polygons, contours, points, depths, meshes, convex hulls, etc.), and/or in any suitable format. Examples of compressed quilt videos can include zigzag compression, differenced quilt images (e.g., quilt image frames where a subset of quilt images can act as key frames and other quilt images can be differenced quilt images relative to nearby, preceding, succeeding, etc. key frames), video compression (e.g., as shown for example in FIG. 14A or FIG. 14B), and/or can be compressed in any manner. As a specific example (shown for instance in FIG. 14A), a quilt video can be compressed in a video format (e.g., where the video can be compressed using a video codec). In this specific example, an N frame quilt video where each quilt image (e.g., quilt frame) of the quilt video includes M views can be compressed into an N×M frame video. In this specific example, the first N frames can be a first view of the quilt images (e.g., each successive frame of the first view of the quilt images), the second N frames can be a second view of the quilt images (e.g., each successive frame of the second view of the quilt images), and so on until all of the views are present. In a variation of this specific example (as shown for instance in FIG. 14B), the first N frames of the video can be a first view of the quilt images (e.g., each successive frame of the first view of the quilt images from frame 1 to frame N), the second N frames can be a second view of the quilt images (e.g., each successive frame of the second view of the quilt images from frame N to frame 1), and so on until all of the views are present (e.g., alternating from frame 1 to N to frame N to 1 and so on). In this specific example (and its variations), a number of key frames can match the number of views (e.g., each first instance of a new view can be a key frame), a number of key frames can be less than a number of views (e.g., one key frame per 2 views, 3 views, 5 views, 10 views, M/2 views, M views, etc.), can be greater than a number of views (e.g., 2 key frames per view, 3 key frames per view, 5 key frames per view, 10 key frames per view, 20 key frames per view, N key frames per view, N/2 key frames per view, N/5 key frames per view, N/10 key frames per view, N/20 key frames per view, N/30 key frames per view, N/50 key frames per view, N/100 key frames per view, etc.), can depend on a number of frames (e.g., N, N×M, etc.), and/or can be any suitable number of key frames (where more key frames can result in higher fidelity but can also result in larger data sizes making transmission slower, lossier, etc.).

In variants of the method including formatting the content, the content is preferably formatted once (e.g., from a proprietary or nonuniversal format to a shared representation, universal representation, shared format, shared representation, etc.).

Receiving the content can include generating auxiliary images (e.g., from one or more perspectives, particularly perspectives not present in the as received content). The auxiliary images can be generated using interpolation (e.g., between two or more images of a plurality of received images), artificial intelligence (e.g., machine learning, neural network, etc.), transformations (e.g., rotation, scaling, translation, etc. of images to generate auxiliary images), and/or in any manner.

As an illustrative example (as shown for instance in FIG. 13), one or more images can be input into a neural network (e.g., a convolutional neural network) which can generate a neural radiance field (NeRF) (e.g., a deformable neural radiance field), a quilt image (e.g., directly, from a NeRF, etc.), a depth quilt (e.g., directly, from a NeRF, etc.), and/or otherwise generate additional views or images and/or convert content into 3D content.

In some variants, 2D content (e.g., 2D images, 2D videos, etc.) can be received, where the 2D content can be transformed into 3D content. For example, 2D content can be transformed to 3D content using artificial intelligence (e.g., machine learning, neural network, etc.). For instance, a neural network can be used to determine (e.g., estimate, predict, etc.) a depth to each pixel of the 2D content, where the resulting depth map (e.g., synthetic depth information) can be combined with the 2D content to create a depth image. In variations, the resulting depth image can be used to generate a plurality of views, where the plurality of views can be arranged as a quilt image. In another example, a neural network can be trained to generate a quilt image from a single input image (e.g., generate auxiliary views directly from the 2D image such as with one or more hidden layers that can determine a depth and one or more hidden layers that can function to generate views or images).

When the content includes extrasensory content (e.g., audio), the extrasensory content can be included with the content (e.g., as metadata, in a shared container, etc.), provided separately from the content (e.g., in a separate container that can be synchronized with the content), and/or can otherwise be provided.

The content can be received automatically, manually, and/or in any manner. In a first specific example, the content can be hosted at or served from a URL (e.g., webpage, file transfer, email, database access, etc.), where the content is received when a viewer accesses the URL (e.g., browses a particular website). In a second specific example, the content can be accessed by browsing to a link (e.g., to a particular URL, gif link, etc.). In variations of the first or second specific example, the same embed and/or link can be used by any display (e.g., in S200, S300, etc.). However, a different embed and/or link can be provided (e.g., depending on a display).

In some variants, receiving the content (and/or the received content) can include 2D data overlaid on (e.g., included with) the content. However, the 2D data can be obscured by the content and/or otherwise be arranged. For instance, a label (e.g., name, identifier, etc.) can be applied to a subject or feature of a scene in the content. When displayed (e.g., in S300), the overlaid data preferably floats over the content (e.g., displayed image, 3D image, etc.), thereby obscuring portions of the content. While displaying overlaid data, the overlaid data is preferably substantially the same when viewed from different perspectives (e.g., whereas the content changes from different perspectives). However, the overlaid data can differ for different perspectives (e.g., have quasi-3D qualities or characteristics, appear 2.5D, etc.). In some variants, the overlaid data can enhance a perceived depthiness of the content (e.g., by acting as a relative fixed point while the content appears to change in different perspectives). However, 2D data can additionally or alternatively otherwise be associated with the content (e.g., in metadata, hoverover text, etc.).

In variants including determining a display S200, S200 can function to identify a type of display that is being used. The display can be determined automatically, manually (e.g., input by a viewer, input by a content creator, etc.), and/or can otherwise be determined. The display can be determined before, after, and/or at the same time as the content is received. In an illustrative example, the display can be determined according to the webXR standard (e.g., for determining an XR headset, for identifying connected displays). However, the display can be determined in any manner (e.g., detecting device drivers, detecting connected device(s), detecting nearby devices, manually selected, etc.).

Determining a display can include determining a richness of a display, modifying a richness of the content (e.g., to match a richness of the display, based on a data bandwidth for content transmission to the display, etc.), and/or can include any suitable steps.

The richness of the display (and/or content) can be a label (e.g., ‘low,’ ‘medium,’ high; etc.), can be a value (e.g., richness on a scale of 1-10, 0-100, etc.), and/or can otherwise be described. The richness can be associated with (e.g., depend on) the display, the content, viewer preferences, content generation means, extrasensory content, and/or associated with any suitable properties. As an illustrative example, a display richness can be determined by determining a display type and determining a display richness associated with the display type (e.g., based on a set of training data from similar or the same display(s)). However, the display richness can otherwise be determined.

The same content (e.g., the same link to the content, quilt image, RGBD data, depth quilt, content in the shared representation, etc.) can generate and deliver different forms of media. For example, one form can be a lower richness content (e.g., when the content is viewed in a low richness platform such as Discord, Slack, e-mail, etc.; such as a temporally changing type, wiggle gif, input-responsive image, etc.) and another form can be a higher richness content (e.g., when viewed in a high richness platform such as a holographic display, XR headset, browser window, etc.; such as a controllable, spatially changing type, etc.). When a viewer selects the content within a low-richness platform, the content can be opened in a higher richness platform (e.g., a browser, a connected display, a higher-richness environment on the display, etc.). For example, when a viewer using a headset observes content in an instance of Discord, the user can select the content to be opened in a browser which can enable a higher richness presentation of the content.

In a first illustrative example, when a display includes a mobile device, the content can be configured to change image and/or perspective as a viewer changes an angle of the mobile device (e.g., gyro-responsive change in displayed content, responsive to a touch input from a viewer, etc.). In a second illustrative example, when a display includes a 2D display (e.g., a computer monitor; displaying content within e-mail, discord, etc.; etc.), the content can be configured as a ‘wiggle-gif’ or other image that automatically, responsive to an interaction (e.g., touchscreen interaction, cursor interaction, etc.), and/or otherwise moves between different images and/or perspectives. In a third illustrative example, when a display includes a superstereoscopic display, holographic display, headset, and/or other suitable display, the content can be configured to be displayed as a stereoscopic (or superstereoscopic) 3D content. However, the content can otherwise be configured for any suitable display.

Displaying the content S300 preferably functions to present the content to one or more viewers through a display. The content can be presented in a single display, a plurality of displays (e.g., on a computer monitor and an auxiliary display such as a holographic or superstereoscopic display connected to the computing system), and/or using any suitable displays (e.g., where each display can present content to one or more viewers). The content is preferably displayed based on the display (e.g., the display as determined in S200), but can be displayed agnostic to display (e.g., without accounting for a richness of a display, without accounting for display capabilities or limitations, etc.) and/or can otherwise be displayed.

The content can be displayed automatically, manually, responsive to a trigger or input, and/or in any suitable manner. For example, a viewer can select content to be displayed using the display.

The content is preferably displayed within a bounded region (e.g., frame, box, bounding box, boundary region, etc.). However, the content can be unbounded. The boundary region can be introduced within the browser, be set by a viewing volume of the display (as shown for example in FIG. 4, a frame of the display, optical guides of the display, etc.), and/or can otherwise be present. The boundary can be explicitly presented (e.g., showing the limits of the content) and/or can be hidden (e.g., content can be bounded without showing where the bounds end).

The bounded region can provide a technical advantage of enhancing a perceived three dimensionality (e.g., depth, depthiness, etc.) of the content and/or providing a faux-parallax effect (e.g., in a display that can only or predominantly produce a parallax effect in a single axis the bounding regions can generate the illusion of some parallax in an orthogonal direction). In some variations, a bounded region can be modified (e.g., digitally modified) to further enhance the perceived three dimensionality. For instance, the size, shape, perspective, color, hue, saturation, effects, and/or other aspect(s) of the bounding region can be modified or controlled to impact a perception of the content. The bounding box modifications can be preset (e.g., generated once upon generation of the bounding box, without regard for content within the bounding box, etc.), dynamically generated (e.g., as the perspective changes, responsive to the content, etc.), and/or can be determined in any manner.

As a first example, the bounding region can generate a shadow in a background near (e.g., neighboring, behind, etc.) the bounding region. In the first example, as different perspectives of the content are viewed, the shadow of the bounding region can move (e.g., in a synchronized manner with the perspectives). Additionally or alternatively, a color, hue, intensity, size, shape, or other property of the shadow can be changed for different perspectives. As a second example, the bounding region shape can change depending on the perspective of the content being viewed. For instance, a bounding box can be rectangular when viewed straight on (e.g., for a central or centered perspective) and can be trapezoidal when viewed from an angle (e.g., an edge perspective with a rotation relative to the central perspective about a single axis). As a third specific example, the bounding box can be used to obscure and/or hide portions of the content from a one or more views or perspectives (which can be used to produce an illusion of vertical or horizontal parallax when little or none is presented, which can). Combining two or more of the preceding specific examples of bounding region modifications can further enhance the perceived and/or perception of depth (however, a single example can be used at a time).

In some variants, the bounding box (e.g., size, shape, etc.) can depend on the content, depend on the display, depend on the viewer, depend on the depth of the content (e.g., depth to the subject, distance to features of the scene, etc.), amount of content to be displayed (e.g., number of pieces of content to be displayed on the same screen, number of pieces of content that can be displayed at the same time by a screen, etc.), a resolution of the display, and/or can otherwise depend on any suitable information.

In a specific example, a viewer using a display (e.g., a head-set based display) can view content, where the content is bounded (e.g., showing or hiding a frame or other boundary). In this specific example, the field-of-view outside of the bounded region can include activated pixels (e.g., appear white, red, blue, green, etc.), inactive pixels (e.g., appear black), a background (e.g., a background specified by the content; one or more colors, designs, hues, patterns, etc. derived from the content; a viewer selected background; etc.), and/or can otherwise be filled and/or unfilled (e.g., used or not used to display light that is associated or unrelated to the content).

When multiple pieces of content are present (e.g., as shown for instance in FIG. 3), a single piece of content can be displayed, multiple pieces of content can be displayed (e.g., with a full attainable richness for each content, with different richness for each content, etc.), and/or any suitable content can be displayed. Each piece of content is preferably associated with a separate bounding box (e.g., frame, box, region, etc.). However, in variants, a plurality of pieces of content can share a bounding box (e.g., where one piece of content can be used to augment another piece of content such as disclosed in U.S. patent application Ser. No. 17/535,449 filed 24 Nov. 2021 titled ‘SYSTEM AND METHOD FOR AUGMENTING LIGHTFIELD IMAGES’ incorporated in its entirety by this reference; where one piece of content can overlap another piece of content; where a piece of content can be used to augment the one or more viewers' environment; etc.), be unbounded, and/or otherwise be related. The boundary (e.g., bounding box) for different content can be the same (e.g., same size, shape, dimensions, resolution, etc.) and/or different (e.g., different sizes, shapes, dimensions, resolution, etc.). The content can be displayed automatically (e.g., based on tracking information such as to display a content that one or more viewers are engaging with in 3D, based on a loading order, based on a location of the content within the browser, based on a location of the content within the display, etc.) and/or manually (e.g., a viewer, content creator, etc. can select content to view, interact with, order of viewing, etc.). As an illustrative example (as shown for instance in FIG. 4), a single piece of content can be selected from the computing system and displayed on a display. In a variation of the illustrative example (as shown for instance in FIG. 5), a piece of content can be selected and displayed in a preferred direction to a viewer where other pieces of content can be displayed (for instance) in a periphery. In another variation, a plurality of content can be presented contemporaneously (e.g., concurrently, simultaneously) on a display (particularly but not exclusively, user device display, computer monitor, headset, etc.), where different content can have the same or different depths (e.g., 2D content and 3D content can be simultaneously present and/or can be separately presented). However, multiple pieces of content can be displayed in any manner.

In some variants, particularly but not exclusively beneficial when the content is displayed on a superstereoscopic or autostereoscopic display, displaying the content can include lenticularizing the content (e.g., mapping pixels of the content to pixels of the display based on a display calibration, applying a lenticular shader, etc.) and/or arranging the images in an order (e.g., assigning an image from the quilt of images to be displayed depending on a viewing angle of the viewer, where the viewing angle can be changed by the viewer moving, by tilting the display, etc.).

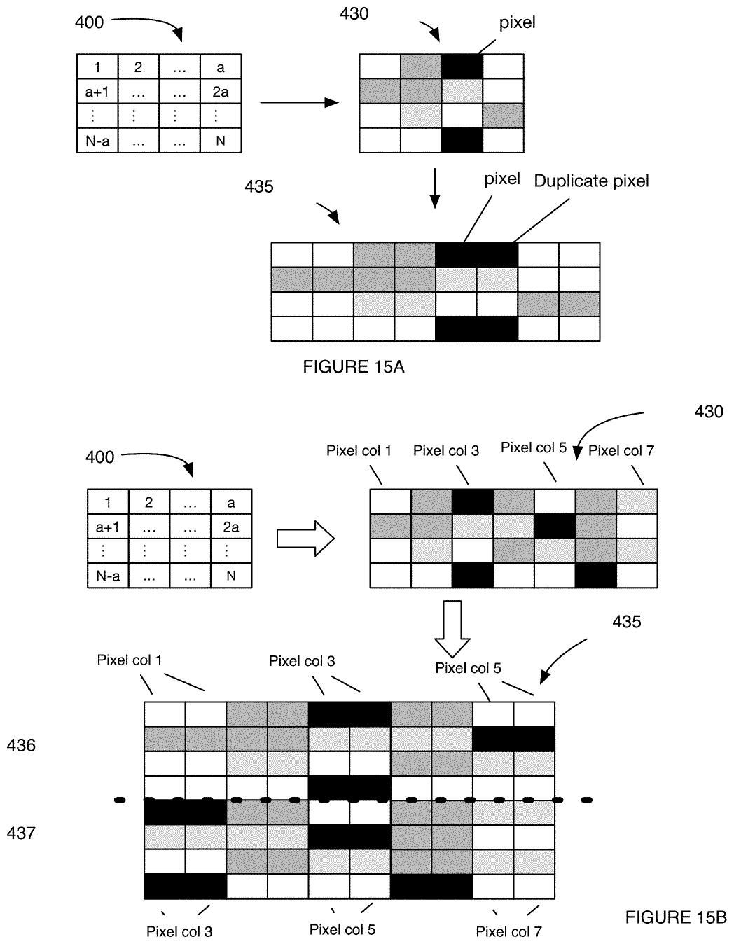

Lenticularizing the content can include duplicating one or more pixel of the lenticular image (also referred to ‘multilenticularization’, as shown for example in FIG. 15A or FIG. 15B). Duplicating the one or more pixels can function to (e.g., provide a technical advantage of) decrease a chromatic anomaly present in the displayed image and/or otherwise function.

Multilenticularization is particularly, but not exclusively, beneficial when the computing system (e.g., a GPU thereof) is able to handle higher resolution images than need to be displayed, but is only able to work with images that use a lossy image format (such as a format that is not pixel perfect, that does not perfectly preserve color, etc.). The number of multiples for duplication can be associated with the degree of lenticularization. For example, as shown in FIG. 15A, a lenticularized image that has been duplicated once (e.g., such that each pixel is represented two times in the resulting lenticularized image) can be referred to as a double-lenticularized image (e.g., double lenticular image). The multiple is preferably an integer, but can be a rational or irrational value. Analogously, the entire lenticularized image (e.g., display-formatted image) is preferably duplicated. However, any subset of the lenticularized image can be duplicated. In specific examples, particularly when the image compression retains approximately half of the pixel color information (e.g., YUV420 color model), double lenticularization (e.g., lenticularization with a multiple of 2) can be sufficient to mitigate the effects of artifacts arising from the image compression. However, any suitable multiple can be used.

The multilenticularized images can, for example, be generated using nearest neighbor filtering (also referred to as point filtering). However, any suitable algorithm can be used. Multilenticularized images are preferably generated by duplicating the pixel column of the lightfield image a number of times equal to the multiple. For example, as shown in FIG. 15A, each pixel column of a double lenticularized image can be duplicated once (e.g., such each pixel column m in the lenticularized image is mapped to pixel columns 2m−1 and 2m in the double lenticularized image). However, multilenticularized images can additionally or alternatively be generated by duplicating each pixel row, by duplicating each column and each row, by duplicating the pixels along an offset, duplicating a subset of pixels of the image, duplicating the entire lenticularized image (e.g., wherein the duplicate can be appended to the left, right, top, bottom, and/or offset from one of the directions relative to the original lenticularized image), and/or be otherwise generated. Duplicate pixels are preferably adjacent or proximal the duplicated pixel (e.g., where the duplicated pixel can be along one edge or along the center of a contiguous pixel block of the duplicated pixel), but can be otherwise arranged.

In some variants, particularly but not exclusively beneficial when the content is displayed on a 2D display (e.g., with an intent to provide perception of depth in the content), displaying the content can include arranging the images in an order (e.g., assigning an image from the quilt of images to be displayed depending on a viewing angle of the viewer, where the viewing angle can be changed by the viewer moving, by tilting the display, etc.), forming a moving image (e.g., a ‘wiggle gif’) based on the arrangement of view, and/or can include any suitable processes.

The content can be rendered (e.g., converted to a display specific format from a universal content representation) once, once per viewer, once per display, once per instance of the method, for each instance of the method, each time content is received, when content is updated, each time the content is displayed or accessed, once for a given set of parallax conditions, and/or with any suitable frequency or timing. The content can be rendered using a renderer (e.g., rendering engine such as RenderMan, Arnold, V-Ray, Mental Ray, Maxwell, Octane, Redshift, Indigo, etc.), artificial intelligence (e.g., machine learning, neural networks, convolutional neural networks, recurrent neural networks, etc.), ray mapping, virtual camera(s), and/or using any suitable method and/or algorithm.

In some variants, displaying the content can include one or more viewers interacting with the content. For example, users can zoom, rotate, navigate around, pan, set a focal plane (e.g., as described in U.S. patent application Ser. No. 17/831,643 titled ‘SYSTEM AND METHOD FOR PROCESSING THREE DIMENSIONAL IMAGES’ filed 3 Jun. 2022 which is incorporated in its entirety by this reference), and/or otherwise interact with the content. The interaction can be mediated by (e.g., input with, detected with, etc.) a user input device (e.g., touchscreen, mouse, controller, trackpad, touchpad, trackball, etc.), an image sensor, and/or using any suitable device. Additionally or alternatively, interaction with the content can be automatically controlled (e.g., be preset by a content creator, determined using a machine learning algorithm, based on an environment proximal the viewer such as lighting proximal the viewer, etc.) and/or can be controlled in any manner.

As a first illustrative example (as shown for instance in FIG. 6), such as for a viewer using a smart phone display, the content (e.g., 3D content) can be displayed as a ‘wiggle gif’ (e.g., an image that cycles through different views at a predetermined frequency). In a second illustrative example (as shown for instance in FIG. 11), the content can be displayed as a static image, where the displayed image can change as the viewing angle changes (e.g., as the smart phone is tilted, panned, etc. such as detected using gyroscope data from a display; as the viewer changes position relative to the display; etc.). In a variation of the second illustrative example, the content can be displayed as a static image, where the viewer can change which static image (e.g., perspective from the plurality of perspectives, view from a plurality of views, etc.) is displayed (e.g., by swiping, selecting an image, etc.). In the second specific example and variations thereof, viewing angle (e.g., as detected using gyroscope data, tracking sensors, cursors or other selection tool, etc.) and user input can be combined to determine a displayed view or image perspective (e.g., a user touch event can set a forward direction of the light field and a change in the gyroscope data can be used to augment that directionality). In a third illustrative example (as shown for instance in FIG. 4), such as for one or more viewers using a superstereoscopic display, a plurality of images from the content (e.g., quilt image) can be displayed simultaneously, where each image of the plurality of images is presented to a different viewing angle (e.g., a first image is displayed in a first direction, a second image is displayed in a second direction different from the first direction, etc. such as based on a coupling between a display pixel and a parallax generator of the display). In a fourth illustrative example (as shown for instance in FIG. 5), for viewer(s) using a headset or other tracked display (e.g., a display as disclosed in U.S. patent application Ser. No. 17/877,757 titled ‘SYSTEM AND METHOD FOR HOLOGRAPHIC DISPLAYS” filed 29 Jul. 2022 which is incorporated in its entirety by this reference), a first image (or set of images) and a second image (or set of images) can be displayed where the first image can be associated with a first eye of the viewer and the second image can be associated with a second eye of the viewer. However, the content can otherwise be displayed.

As a second specific example, received content (e.g., received at a server, received by a viewer, received by a remote computing system, etc.) can include an image (e.g., an RGB image, 2D image, vector format image, compound format images, raster format images, etc.). A depth associated with the image (e.g., a depth associated with each pixel of the image) can be determined (e.g., using a machine learning algorithm such as a neural network trained to estimate or predict depth on a set of training data with images similar to the scene or subject of the content, based on parallax cues in the scene, based on one or more input depths in the scene, based on a scale bar included in the scene, etc.). Using the depth information (e.g., derived depth) and the color information for each pixel of the image, a plurality of views from different perspectives can be created (e.g., using a set of virtual cameras at the positions associated with each perspective, by projecting the image onto different perspective based on the depth and the perspective orientation, etc.). The plurality of views can then be converted to a universal content format or representation (e.g., a quilt image, a depth quilt when each view or a plurality of views includes an associated depth, a depth image, etc.). The universal content representation can be accessed (e.g., by a display, by a viewer, etc.), where the universal content representation can optionally (e.g., depending on the display type) have a shader applied (e.g., via webXR, via a display computing system, using a system as described in U.S. patent application Ser. No. 17/724,369 titled ‘SYSTEM AND METHOD FOR DISPLAYING A THREE-DIMENSIONAL IMAGE’ filed 19 Apr. 2022 which is incorporated in its entirety by this reference, etc.) to convert the universal content representation to a display specific representation (where display specific can be specific to a type of display, to a single display, to a network of displays, etc.). The content can then be displayed on the display (e.g., using the display specific representation).

In a first variation of the second specific example, the received content can include a plurality of images. For instance, the plurality of images can include stereo images (e.g., in a stereo image format, as an image pair, etc.), a photoset, images acquired at different times (e.g., using a photorail, using an image acquisition system as described in U.S. patent application Ser. No. 17/575,427 titled ‘SYSTEM AND METHOD FOR LIGHTFIELD CAPTURE’ filed 13 Jan. 2022 which is incorporated in its entirety by this reference, etc.), images with different characteristics (e.g., a color image and a thermal image), and/or any suitable images can be received. The depth to pixels of the image can be determined using a machine learning algorithm (e.g., that ingests each image, that ingests a single image, etc.), a stereoimage algorithm (e.g., using Harris algorithm, features from accelerated segment test (FAST), using oriented FAST and rotated binary robust independent elementary features (BRIEF) (ORB), speeded-up robust features (SURF), scale invariant feature transform (SIFT), binary robust invariant scalable keypoints (BRISK), simultaneous localization and mapping (SLAM), etc.), and/or can be determined in any manner.

In a second variation of the second specific example, the content can be received as a depth image (e.g., RGBD image). For instance, the depth image can be acquired using a depth camera (e.g., a structured light camera, coded light camera, active stereo camera, time-of-flight camera, etc.). However, the depth image can otherwise be generated. In this variation, rather than using synthetic or derived depth, the measured depth can be used. However, additionally or alternatively, a derived depth (e.g., determined in a manner as described for a 2D image or plurality of images) of the depth image can be determined or used.

In a third variation of the second specific example, the image can be a frame of a video, where the content can be or include the video. In this variation, each image can be processed in a similar manner where the resulting universal content representation for each frame can be combined to form a 3D video. However, additionally or alternatively, a plurality of frames of the video can be processed concurrently to generate a plurality of frames in the universal content representation concurrently (e.g., leveraging optical flow algorithms; facilitating compression, storage, transmission, etc.; etc.), can be processed using a unique video flow to produce a universal video content representation (e.g., quilt video, depth quilt video, depth video, etc.), and/or can otherwise be used to generate 4D content (e.g., content with 3 spatial dimensions and a temporal dimension).

In a third specific example, the received content can include a neural radiance field (NeRF or related formats such as regularized NeRF (RegNeRF), pixelNeRF, GAN-based Nerf (GNeRF), etc.; for example generated using a neural network to optimize a volumetric scene from one or more image, etc.) and/or lightfield images (e.g., captured using a lightfield camera, captured using a plenoptic camera, etc.). The use of NeRF (and/or related variations including lightfield images) can provide a technical advantage of enabling real- or near-real time rendering of a scene (e.g., to produce new perspectives, to facilitate augmentation or changing augmentation of the scene, etc.). In this specific example, a rendering engine (e.g., virtual camera(s)) can be used to convert from a NeRF to a universal content representation in a similar manner as for images or 3D models. The universal content representation can be accessed (e.g., by a display, by a viewer, etc.), where the universal content representation can optionally (e.g., depending on the display type) have a shader applied (e.g., via webXR, via a display computing system, using a system as described in U.S. patent application Ser. No. 17/724,369 titled ‘SYSTEM AND METHOD FOR DISPLAYING A THREE-DIMENSIONAL IMAGE’ filed 19 Apr. 2022 which is incorporated in its entirety by this reference, etc.) to convert the universal content representation to a display specific representation (where display specific can be specific to a type of display, to a single display, to a network of displays, etc.). The content can then be displayed on the display (e.g., using the display specific representation).

In a variation of the third specific example, the NeRF can be a frame of a video, where the content can be the video. In this variation, each NeRF can be processed in a similar manner where the resulting universal content representation for each frame can be combined to form a 3D video. However, additionally or alternatively, a plurality of frames of the video can be processed concurrently to generate a plurality of frames in the universal content representation concurrently (e.g., leveraging optical flow algorithms; facilitating compression, storage, transmission, etc.; etc.), can be processed using a unique video flow to produce a universal video content representation (e.g., quilt video, depth quilt video, depth video, etc.), and/or can otherwise be used to generate 4D content (e.g., content with 3 spatial dimensions and a temporal dimension).

The methods of the preferred embodiment and variations thereof can be embodied and/or implemented at least in part as a machine configured to receive a computer-readable medium storing computer-readable instructions. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method comprising:
receiving a two dimensional (2D) image of a scene;
determining a display type of a display;
converting the 2D image to a three dimensional (3D) image, wherein the 3D image is formatted in a shared representation that can be used regardless of the display type, wherein a perceived quality of the 3D image can be determined based on the display type;
displaying the 3D image on the display, wherein the display is at least one of:
a computer monitor;
an autostereoscopic display;
a virtual reality or augmented reality headset;
a mobile device; or
a tracked 3D display.

2. The method of claim 1, wherein the 3D image format comprises at least one of a quilt image, a depth quilt, a depth image, or a neural radiance field.

3. The method of claim 2, wherein converting the 2D image to a 3D image comprises using a machine learning algorithm to estimate a depth to pixels of the image.

4. The method of claim 3, wherein converting the 2D image to a 3D image comprises using a plurality of virtual cameras to render a plurality of views of the 2D image from different perspectives based on the depth to pixels of the 2D image, wherein the plurality of views are arranged as a quilt image.

5. The method of claim 1, wherein when the display is an autostereoscopic display, displaying the 3D image on the display comprises aligning each pixel of the 3D image to a respective pixel of the autostereoscopic display based on a calibration of the autostereoscopic display.

6. The method of claim 5, further comprising duplicating each aligned pixel of the 3D image to the respective pixel of the autostereoscopic display, wherein each pair of duplicate pixel is displayed by approximately one pixel of the display.

7. The method of claim 5, wherein aligning each pixel of the 3D image to a respective pixel of the autostereoscopic display based on the calibration of the autostereoscopic display is performed in a remote computing environment.

8. The method of claim 1, wherein the 2D image is a frame of a video of the scene.

9. The method of claim 8, wherein the video comprises N frames, wherein the video is compressed to form a compressed video comprising N×M frames, wherein M is a number of perspectives associated with the 3D image, wherein the frames of the compressed video are determined based on the perspectives of the 3D image, wherein the compressed video is transmitted to the display.

10. A system comprising:
a display comprising at least one of:
a computer monitor;
an autostereoscopic display;
a virtual reality or augmented reality headset;
a mobile device; or
a tracked 3D display; and
a processor configured to:
receive content associated with a scene, wherein the content comprises at least one of:
a 2D image;
a depth image;
a captured depth image;
a panoramic image;
a 3D model; or
a neural radiance field;
convert the content to a shared three-dimensional (3D) representation; and
transmit the shared 3D representation of the scene to the display, wherein the display is configured to present a 3D image of the scene.

11. The system of claim 10, wherein the display is configured to present the 3D image of the scene within a bounding box, wherein the bounding box enhances a perception of depth in the 3D image.

12. The system of claim 11, wherein the bounding box enhances the perception of the depth by changing a shadow of the bound box within the display based on a perspective of a viewer.

13. The system of claim 11, wherein when the display comprises the autostereoscopic display, the bounding box is a frame of the autostereoscopic display.

14. The system of claim 10, wherein the 3D representation comprises at least one of a quilt image or a depth quilt.

15. The system of claim 10, wherein the content is a frame of a video, wherein the 3D representation is transmitted by:
arranging the 3D representation such that views associated with a common perspective are grouped together;
compressing the arranged 3D representation using a video codec; and
transmitting the compressed 3D representation.

16. The system of claim 10, wherein the processor is integrated in a cloud computing server.

17. The system of claim 16, wherein when the display comprises an autostereoscopic display, the processor is further configured to receive a calibration of the display and lenticularized the shared 3D representation using the calibration.

18. The system of claim 17, wherein lenticularizing the shared 3D representation further comprising for each pixel of the lenticular image duplicating forming a duplicate of the respective pixel immediately adjacent to the respective pixel.

19. The system of claim 10, wherein the display is configured to present a second piece of content proximal the content, wherein the second piece of content is presented as two-dimensional.

20. The system of claim 10, wherein converting the 2D image to a shared 3D representation comprises using a machine learning algorithm to estimate a depth to pixels of the image and rendering a plurality of views of the scene image from different perspectives based on the depth to pixels of the 2D image.
